(19) United States
(12) Patent Application Publication
(10) Pub. No.: US 2007/0204699 A1
(43) Pub. Date: Sep. 6, 2007

(54) Remote strain measurement

(75) Inventors: Joseph James Salvo, Schenectady, NY (US); Ronald Sheldon Carpenter, Hamilton, OH (US); Michael Orlando Cimini, Fairfield, OH (US); Lynn Ann Derose, Gloversville, NY (US); Douglas Roy Forman, Niskayuna, NY (US); Lee roy Lapierre, Woburn, MA (US); Craig Douglas Young, Clifton Park, NY (US); Charles Burton Theurer, Clifton Park, NY (US)

Correspondence Address: Berkely Law & Technology Group, LLC, Suite 240, 1700 NW 167th Place, Beaverton, OR, 97006, US

(73) Assignee: General Electric Company

(21) Appl. No.: 11/367,245

(22) Filed: Mar. 2, 2006

(51) Int. Cl. F16B 31/02

(52) U.S. Cl. 73/761

(57) ABSTRACT

Briefly, in accordance with one or more embodiments, a sensor assembly may measure in a mechanical device and communicate an indication of the measured to a remote device via a wireless link.

### BACKGROUND

Mechanical couplings, such as bolts and/or nuts, on various types of engines and motors are typically tightened to a certain pressure during the assembly process. During the inspection process, these mechanical couplings are often re-tightened multiple times to avoid releasing during engine start-up. During maintenance, workers may not know if these mechanical couplings are tight or not and will spend extra time checking their status.

For example, non-tightened B-nut type mechanical couplings on the hydraulic system of an aircraft engine must be torqued to a specified level before the engine can be tested. The mechanical couplings are tightened and checked several times by several people in the service and assembly of an aircraft engine. However, the number of hydraulic connections and the physical complexity of the aircraft engine make it difficult to track the state of each mechanical coupling. While the aircraft engine is on-wing, it is tested at partial load on the tarmac. However, leakage may not occur until high power is reached for the first time in flight. Thus, if a mechanical coupling on a hydraulic line is not tight, the status may not be known until the aircraft engine is brought to full load and this is often in the air. The result of a loose coupling may be an in-flight shutdown of the aircraft engine to avoid engine damage, resulting in an aborted mission and/or rerouting of the flight.

### BRIEF DESCRIPTION OF DRAWINGS

Subject matter is particularly pointed out and distinctly claimed in the concluding portion of the specification. The claimed subject matter, however, both as to organization and method of operation, together with objects, features, and advantages thereof, may best be understood by reference of the following detailed description when read with the accompanying drawings in which:

FIG. 1 is a block diagram illustrating an example remote strain measurement system, in accordance with one or more embodiments;

FIG. 2 is a block diagram illustrating an example remote strain measurement system, in accordance with one or more embodiments;

FIG. 3 is a block diagram illustrating an example remote strain measurement system, in accordance with one or more embodiments;

FIG. 4 is a flow diagram illustrating an example procedure for remote strain measurement, in accordance with one or more embodiments;

FIG. 5 is a flow diagram illustrating an example procedure for remote strain measurement, in accordance with one or more embodiments; and

FIG. 6 is a flow diagram illustrating an example procedure for remote strain measurement, in accordance with one or more embodiments.

### DETAILED DESCRIPTION

In the following detailed description, numerous specific details are set forth to provide a thorough understanding of the claimed subject matter. However, it will be understood by those skilled in the art that the claimed subject matter may be practiced without these specific details. In other instances, well-known methods, procedures, components and/or circuits have not been described in detail so as not to obscure the claimed subject matter.

Additionally, reference is made in the following detailed description to the accompanying drawings which form a part hereof wherein like numerals may designate like parts throughout, and in which is shown by way of illustration specific embodiments that may be realized. It is to be understood that other embodiments may be utilized and structural and/or logical changes may be made without departing from the scope of the claimed subject matter. It should also be noted that directions and references, for example, up, down, top, bottom, and so on, may be used to facilitate the discussion of the drawings and are not intended to restrict the application of the claimed subject matter. Therefore, the following detailed description is not to be taken in a limiting sense and the scope of the claimed subject matter defined by the appended claims and their equivalents.

Reference throughout this specification to “one embodiment” or “an embodiment” means that a particular feature, structure, or characteristic described in connection with the embodiment is included in at least one embodiment of the claimed subject matter. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

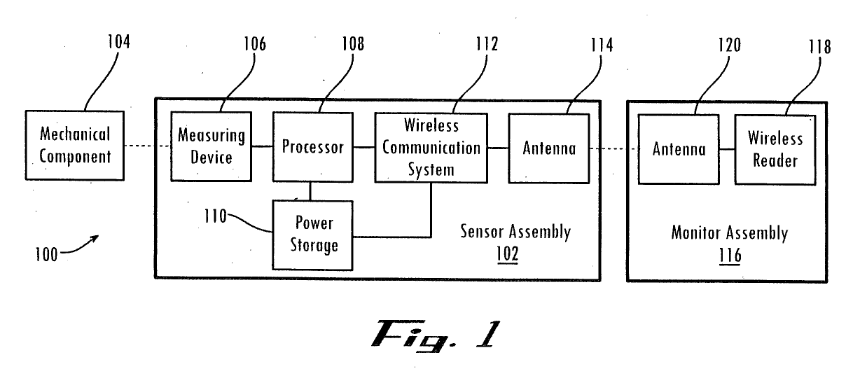

Referring to FIG. 1, a block diagram illustrates a remote strain measurement system 100 according to one or more embodiments, although the claimed subject matter is not limited in scope in this respect. Remote strain measurement system 100 may include more components than those shown in FIG. 1. However, generally conventional components may not be shown. Illustrated in FIG. 1, remote strain measurement system 100 may include a sensor assembly 102. Sensor assembly 102 may be attached to a mechanical component 104. As used herein, the term mechanical component 104 may be any suitable mechanical component capable of providing structural support and/or coupling one or more mechanical pieces together, according to the particular application. Additionally or alternatively, mechanical component 104 may include one or more of the following: a mechanical coupling, a structural part, a thermal part, or an electromechanical part, or combinations thereof. Examples of suitable mechanical component 104 may include, but are not limited to a mechanical coupling such as a nut, a bolt, a screw, or a rivet, or the like, or a combination thereof, although the scope of the claimed subject matter is not limited in this respect. Sensor assembly 102 may be permanently, or nearly permanently, attached to mechanical component 104. For example, sensor assembly 102 may be permanently, or nearly permanently, attached to mechanical component 104 by being incorporated into mechanical component 104, by an adhesive, by a fastener, or the like, or combinations thereof, although the scope of the claimed subject matter is not limited in this respect.

Sensor assembly 102 may include a measuring device 106. Measuring device 106 may be capable of sensing one or more stimuli, including, but are not limited to heat, light, sound, pressure, magnetism, and/or physical motion, or the like. For example, measuring device 106 may be a strain measuring device capable of sensing one or more stimuli including, but not limited to strain, although the scope of the claimed subject matter is not limited in this respect. Examples of a suitable strain measuring device 106 may include, but are not limited to magnetic field sensors, acoustic sensors, electric signal sensors, spectra sensors, or the like, although the scope of the claimed subject matter is not limited in this respect. Additionally or alternatively, examples of a suitable strain measuring device 106 may include, but are not limited to a contact switch that may be activated between the mechanical component 104 and another object (not shown) if the mechanical component 104 reaches a certain pressure, and/or an embedded chip with a binary setting capable of changing state if the mechanical component 104 reaches a certain pressure, or the like, although the scope of the claimed subject matter is not limited in this respect.

Sensor assembly 102 may include a processor 108. Processor 108 may be coupled to measuring device 106. Processor 108 may be any suitable device capable of polling measuring device 106, according to the particular application. Examples of suitable processors 108 may include, but are not limited to an integrated circuit or the like, although the scope of the claimed subject matter is not limited in this respect.

Sensor assembly 102 may include power storage 110. Power storage 110 may be coupled to processor 108. Power storage 110 may be any suitable device capable of delivering power to processor 108, according to the particular application. Examples of suitable power storage 110 may include, but are not limited to a battery or the like, although the scope of the claimed subject matter is not limited in this respect.

Sensor assembly 102 may include a wireless communication system 112. Wireless communication system 112 may be coupled to measuring device 106 at least through processor 108. Additionally or alternatively, processor 108 may modulate a sensed signal from measuring device 106 into a wireless transmitted signal, although the scope of the claimed subject matter is not limited in this respect. For example, a carrier produced by the processor 108 and/or the wireless communication system 112 may be added to a sensed signal from measuring device 106 to produce a wireless signal. Wireless communication system 112 may be capable of receiving a data from measuring device 106 at least through processor 108. Additionally, wireless communication system 112 may be coupled to power storage 110. Wireless communication system 112 may be capable of delivering and/or receiving power to power storage 110 where power storage 110 is capable of receiving power from wireless communication system 112. As used herein, the term “wireless” may refer to radio frequency (RF) wireless communication, visual wireless communication, optical wireless communication, acoustic, and/or other wireless communication techniques, for example, although other types of wireless communication may alternatively be employed depending on the particular context. As used herein, examples discussing RF wireless communication may encompass alternative wireless communication techniques such as visual wireless communication, optical wireless communication, and/or other wireless communication techniques, for example, although the scope of the claimed subject matter is not limited in this respect.

Sensor assembly 102 may include an antenna 114. Antenna 114 may be coupled to wireless communication system 112. Antenna 114 may be capable of receiving and/or transmitting wireless signals and communicating with wireless communication system 112 based on these wireless signals. For example, wireless communication system 112 and/or antenna 114 may be capable of wirelessly communicating the measured data, such as strain data, from measuring device 106 to a remote receiver via a wireless link, although the scope of the claimed subject matter is not limited in this respect.

One or more of the components of sensor assembly 102 may comprise a radio frequency identification (RFID) tag coupled to measuring device 106. For example, processor 108, power storage 110, wireless communication system 112, and/or antenna 114 may comprise a RFID tag. Examples of suitable RFID tags may include, but are not limited to passive RFID tags, active RFID tags or the like, although the scope of the claimed subject matter is not limited in this respect.

Remote strain measurement system 100 may include a monitor assembly 116 positioned remotely from sensor assembly 102. Monitor assembly 116 may be capable of wireless communication with sensor assembly 116. Wireless monitor assembly 116 may include a wireless reader 118 coupled to an antenna 120. Wireless monitor assembly 116 and sensor assembly 102 may be capable of wireless communication with each other via a wireless link. Additionally or alternatively, sensor assembly 102 may be capable of receiving at least a portion of power from wireless monitor assembly 116, as will be described in greater detail below.

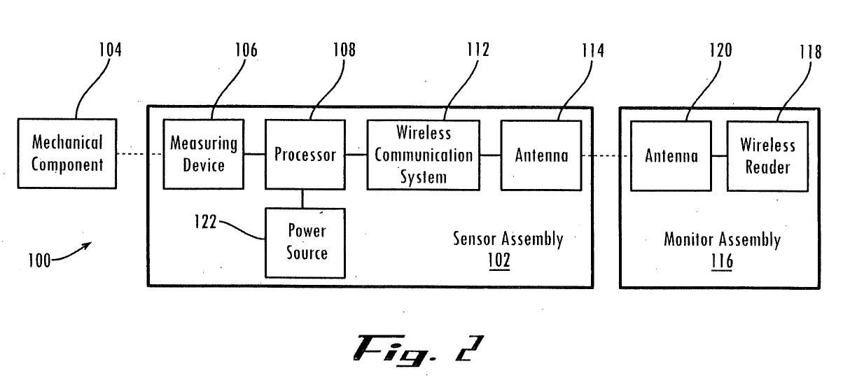

Referring to FIG. 2, a block diagram illustrates a remote strain measurement system 100 according to one or more embodiments, although the claimed subject matter is not limited in scope in this respect. Remote strain measurement system 100 may include more components than those shown in FIG. 2. However, generally conventional components may not be shown. Illustrated in FIG. 2, sensor assembly 102 may include a power source 122. Power source 122 may be coupled to processor 108. Power source 122 may be any suitable device capable of delivering power to processor 108, according to the particular application. Examples of a suitable power source 122 may include, but are not limited to a battery or the like, although the scope of the claimed subject matter is not limited in this respect.

One or more of the components of sensor assembly 102 may comprise a RFID tag coupled to measuring device 106. For example, processor 108, power source 122, wireless communication system 112, and/or antenna 114 may comprise a RFID tag. Examples of suitable RFID tags may include, but are not limited to passive RFID tags, active RFID tags or the like, although the scope of the claimed subject matter is not limited in this respect.

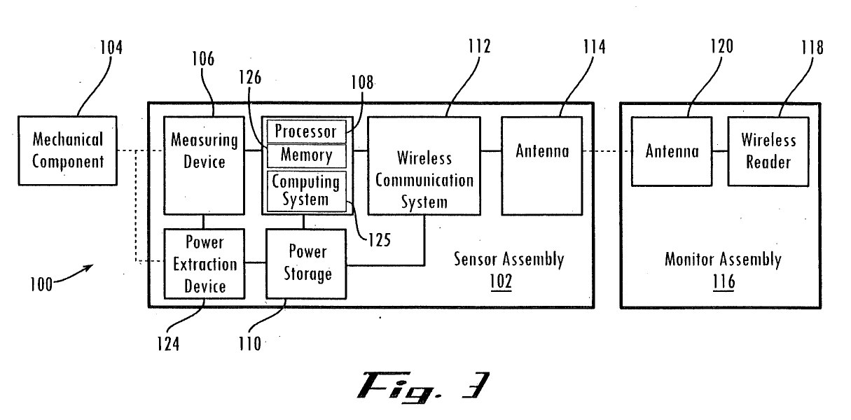

Referring to FIG. 3, a block diagram illustrates a remote strain measurement system 100 according to one or more embodiments, although the claimed subject matter is not limited in scope in this respect. Remote strain measurement system 100 may include more components than those shown in FIG. 3. However, generally conventional components may not be shown. Illustrated in FIG. 3, sensor assembly 102 may include a power extraction device 124. Power extraction device 124 may be coupled to measuring device 106. Additionally or alternatively, power extraction device 124 may be coupled to mechanical component 104. Power extraction device 124 may be any suitable device capable of extracting power from external environment and capable of delivering power to measuring device 106, according to the particular application. Examples of a suitable power extraction device 124 may include, but are not limited to a piezoelectric device or the like, although the scope of the claimed subject matter is not limited in this respect. For example, power extraction device 124 may be a piezoelectric device capable of extracting power from external strain on mechanical component 104 and capable of delivering this extracted power to measuring device 106. Additionally or alternatively, power extraction device 124 may be coupled to power storage 110 and capable of delivering power to power storage 110 for later use.

Sensor assembly 102 may include a computing system 125 including processor 108 and/or a memory 126. Computing system 125 may be coupled to measuring device 106, power storage 110, and/or wireless communication system 114. Memory 126 may be any suitable device capable of storing data delivered from measuring device 106 while not powered, according to the particular application. Examples of suitable memory 126 may include, but are not limited to static random access memory, or dynamic random access memory, or the like, although the scope of the claimed subject matter is not limited in this respect. Additionally, the system 102 shown in FIGS. 1 and/or 2 may include a memory capable of storage of data; however such memory may or may not be capable of storing data delivered from measuring device 106 while not powered, as is the case with memory 126.

One or more of the components of sensor assembly 102 may comprise a RFID tag coupled to measuring device 106. For example, memory 126, power storage 110, wireless communication system 112, and/or antenna 114 may comprise a RFID tag. Examples of suitable RFID tags may include, but are not limited to passive RFID tags, active RFID tags or the like, although the scope of the claimed subject matter is not limited in this respect.

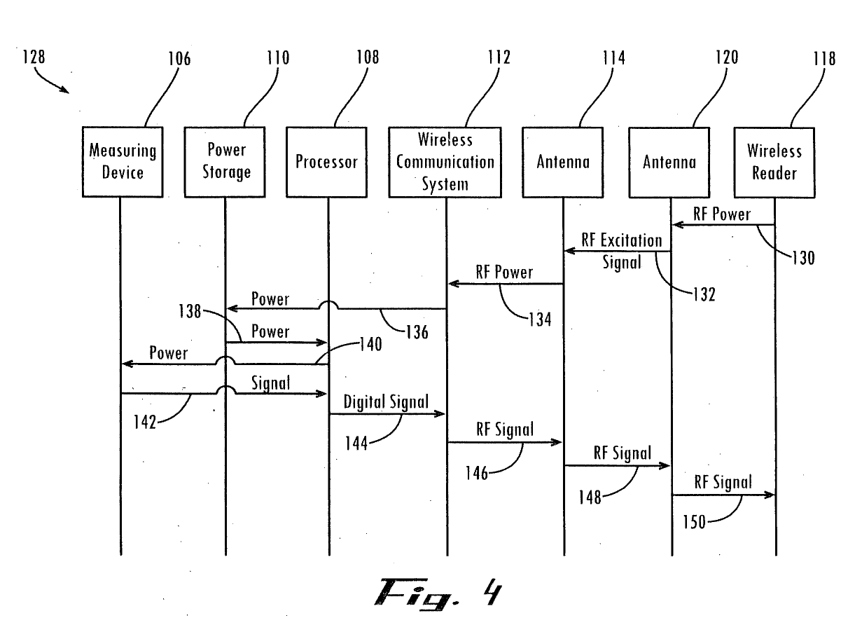

Referring now to FIG. 4, a flow diagram illustrates an example procedure for remote strain measurement, in accordance with one or more embodiments, although the claimed subject matter is not limited in scope in this respect. The flowchart illustrated in FIG. 4 may be used to perform one or more remote strain measurements in a remote strain measurement system 100, such as system 100 of FIG. 1, for example, although the claimed subject matter is not limited in this respect. Additionally, the order in which the tasks are presented does not necessarily limit the claimed subject matter to any particular order. Likewise, intervening additional tasks not shown may be employed and without departing from the scope of the claimed subject matter.

Flowchart 128 depicted in FIG. 4 may in alternative embodiments be implemented in software, hardware and/or firmware, and may comprise discrete operations. As illustrated, wireless reader 118 may send radio frequency (RF) power to antenna 120 at task 130. At task 132, antenna 120 may convert the RF power to a wireless RF excitation signal and may send the wireless RF excitation signal to antenna 114. At task 134, antenna 114 may convert the wireless RF excitation signal to RF power and may send the RF power to wireless communication system 112. At task 136, wireless communication system 112 may send power to power storage 110. At task 138, power storage 110 may send power to processor 108. At task 140, processor 108 may poll measuring device 106 for a measurement by sending power to measuring device 106. At task 142, measuring device 106 may take a measurement, such as strain of mechanical component 104, for example as shown in FIG. 1, may send resultant data and/or state change information in a signal to processor 108. At task 144, processor 108 may send a digital signal including the resultant data and/or state change information to wireless communication system 112. At task 146, wireless communication system 112 may send a RF signal including the resultant data and/or state change information to antenna 114. At task 148, antenna 114 may send a wireless RF signal including the resultant data and/or state change information to antenna 120. At task 150, antenna 120 may send a RF signal including the resultant data and/or state change information to wireless reader 118. In operation, a user may poll measuring device 106 by initiating a remote strain measurement from wireless reader 118, although the claimed subject matter is not limited in scope in this respect. For example, power may be extracted from the RF excitation signal by the wireless communication system 112 where this extracted power may be used to run the processor 108, make a measurement via measuring device 106, and/or transmit the resultant data and/or state change information to the wireless reader 118, although the claimed subject matter is not limited in scope in this respect.

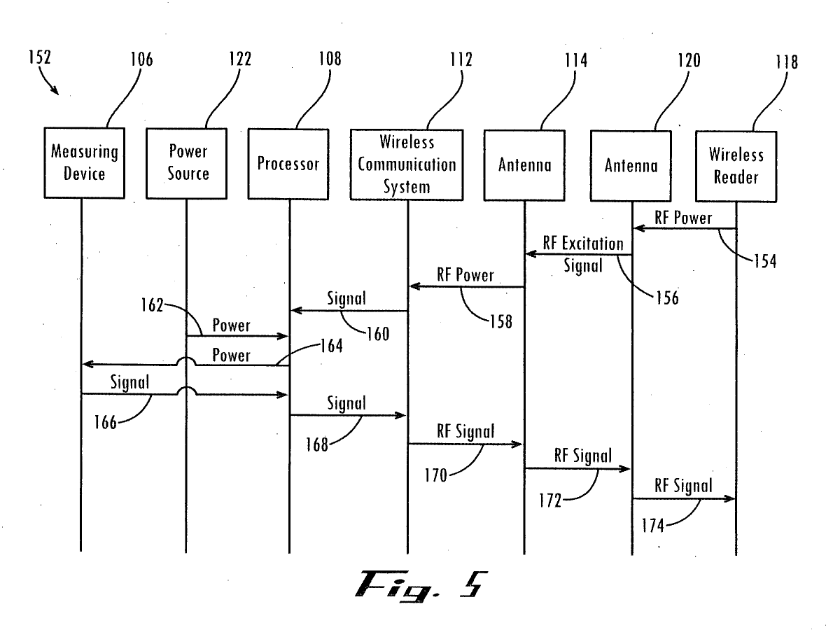

Referring now to FIG. 5, a flow diagram illustrates an example procedure for remote strain measurement, in accordance with one or more embodiments, although the claimed subject matter is not limited in scope in this respect. The flowchart illustrated in FIG. 5 may be used to perform one or more remote strain measurements in a remote strain measurement system 100, such as system 100 of FIG. 2, for example, although the claimed subject matter is not limited in this respect. Additionally, the order in which the tasks are presented does not necessarily limit the claimed subject matter to any particular order. Likewise, intervening additional tasks not shown may be employed and without departing from the scope of the claimed subject matter.

Flowchart 152 depicted in FIG. 5 may in alternative embodiments be implemented in software, hardware and/or firmware, and may comprise discrete operations. As illustrated, wireless reader 118 may send radio frequency (RF) power to antenna 120 at task 154. At task 156, antenna 120 may convert the RF power to a wireless RF excitation signal and may send the wireless RF excitation signal to antenna 114. At task 158, antenna 114 may convert the wireless RF excitation signal to RF power and may send the RF power to wireless communication system 112. At task 160, wireless communication system 112 may send a signal to processor 108 requesting information from measuring device 106. At task 162, power source 122 may send power to processor 108. At task 164, processor 108 may poll measuring device 106 for a measurement by sending power to measuring device 106. Additionally or alternatively, processor 108 may poll measuring device 106 upon a request from wireless reader 118, receive information from measuring device 106 upon a change of condition determined by measuring device 106, and/or routinely poll measuring device 106, although the claimed subject matter is not limited in scope in this respect.

At task 166, measuring device 106 may take a measurement, such as strain of mechanical component 104, for example as shown in FIG. 2, and send resultant data and/or state change information in a signal to processor 108. At task 168, processor 108 may send a digital signal including the resultant data and/or state change information to wireless communication system 112. At task 170, wireless communication system 112 may send a RF signal including the resultant data and/or state change information to antenna 114. At task 172, antenna 114 may send a wireless RF signal including the resultant data and/or state change information to antenna 120. At task 174, antenna 120 may send a RF signal including the resultant data and/or state change information to wireless reader 118. In operation, a user may receive information from measuring device 106 wirelessly communicated from processor 108 to wireless reader 118, although the claimed subject matter is not limited in scope in this respect. For example, power may be extracted from the RF excitation signal by the wireless communication system 112 where this extracted power may be used to send a signal to trigger the processor 108 to make a measurement via measuring device 106 and/or transmit the resultant data and/or state change information to the wireless reader 118, although the claimed subject matter is not limited in scope in this respect.

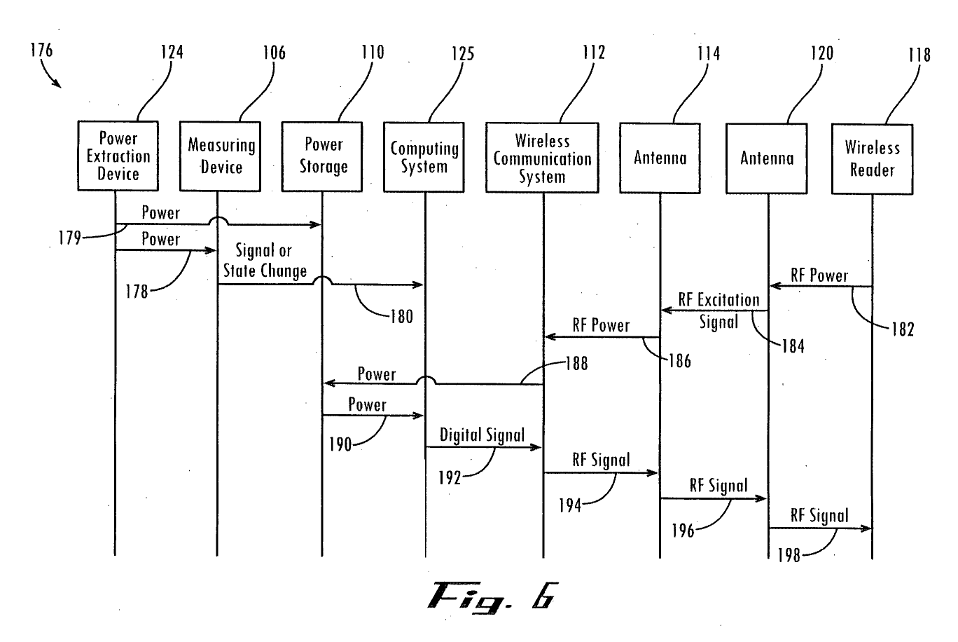

Referring now to FIG. 6, a flow diagram illustrates an example procedure for remote strain measurement, in accordance with one or more embodiments, although the claimed subject matter is not limited in scope in this respect. The flowchart illustrated in FIG. 6 may be used to perform one or more remote strain measurement in a remote strain measurement system 100, such as system 100 of FIG. 3, for example, although the claimed subject matter is not limited in this respect. Additionally, the order in which the tasks are presented does not necessarily limit the claimed subject matter to any particular order. Likewise, intervening additional tasks not shown may be employed and without departing from the scope of the claimed subject matter.

Flowchart 176 depicted in FIG. 6 may in alternative embodiments be implemented in software, hardware and/or firmware, and may comprise discrete operations. As illustrated, power extraction device 124 may extract power from the surrounding environment and may send the extracted power to measuring device 106 at task 178. Additionally or alternatively, power extraction device 124 may extract power from the surrounding environment and may send the extracted power to power storage device 110 for later use at task 179. For example, power extraction device 124 may extract power from strain on mechanical component 104, for example as shown in FIG. 3, although the claimed subject matter is not limited in scope in this respect. At task 180, measuring device 106 may take a measurement, such as strain of mechanical component 104, for example as shown in FIG. 3, and send resultant data signal or state change information to computing system 125. For example, computing system 125 may receive information from measuring device 106 upon a change of condition, such as a state change, determined by measuring device 106, although the claimed subject matter is not limited in scope in this respect. In operation, if mechanical component 104, for example as shown in FIG. 3, is tightened, power extraction device 124 may extract power from strain on mechanical component 104, where the extracted power may be used to make a strain measurement via measuring device 106 and store the strain information in memory 126, although the claimed subject matter is not limited in scope in this respect.

At task 182, wireless reader 118 may send radio frequency (RF) power to antenna 120. At task 184, antenna 120 may convert the RF power to a wireless RF excitation signal and may send the wireless RF excitation signal to antenna 114. At task 186, antenna 114 may convert the wireless RF excitation signal to RF power and may send the RF power to wireless communication system 112. At task 188, wireless communication system 112 may send power to power storage 110 and/or use power to send a signal to computing system 125 wherein processor 108 may reference data from memory 126. At task 190, power storage 110 may send power to computing system 125. At task 192, computing system 125 may send a digital signal including the resultant data and/or state change information to wireless communication system 112. At task 194, wireless communication system 112 may send a RF signal including the resultant data and/or state change information to antenna 114. At task 196, antenna 114 may send a wireless RF signal including the resultant data and/or state change information to antenna 120. At task 198, antenna 120 may send a RF signal including the resultant data and/or state change information to wireless reader 118. In operation, a user may poll information from memory 126 of computing system 125 wirelessly via wireless reader 118 where power may be extracted from the RF excitation signal by the wireless communication system 112 and may then be used to trigger wireless communication system 112 to send the information wirelessly to the reader 118, although the claimed subject matter is not limited in scope in this respect.

It is now appreciated, based at least in part on the foregoing disclosure, that software may be produced capable of performing one or more of the above-described operations. It will also be understood that, although particular embodiments have just been described, the claimed subject matter is not limited in scope to a particular embodiment or implementation. For example, one embodiment may be in hardware, such as implemented to operate on a device or combination of devices, as previously described, for example, whereas another embodiment may be in software. Likewise, an embodiment may be implemented in firmware, or as any combination of hardware, software, and/or firmware, for example. Likewise, although the claimed subject matter is not limited in scope in this respect, one embodiment may comprise one or more articles, such as a storage medium or storage media. This storage media, such as, one or more CD-ROMs and/or disks, for example, may have stored thereon instructions, that when executed by a system, such as a computing system, computer system, computing platform, or other system, for example, may result in an embodiment of a method in accordance with the claimed subject matter being executed, such as one of the embodiments previously described, for example. As one potential example, a computing platform may include one or more processing units or processors, one or more input/output devices, such as a display, a keyboard and/or a mouse, and/or one or more memories, such as static random access memory, dynamic random access memory, flash memory, and/or a hard drive, although, again, the claimed subject matter is not limited in scope to this example.

In the preceding description, various aspects of the claimed subject matter have been described. For purposes of explanation, specific numbers, systems and/or configurations were set forth to provide a thorough understanding of the claimed subject matter. However, it should be apparent to one skilled in the art having the benefit of this disclosure that the claimed subject matter may be practiced without the specific details. In other instances, well-known features were omitted and/or simplified so as not to obscure the claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of the claimed subject matter.

What is claimed is:

1. An apparatus, comprising:
a mechanical component; and
a sensor assembly attached to the mechanical component, wherein the sensor assembly comprises:
a measuring device; and
a wireless communication system coupled to the measuring device.

2. The apparatus of claim 1, wherein the measuring device comprises a strain measuring device.

3. The apparatus of claim 1, wherein the mechanical component comprises one or more of the following a mechanical coupling, a structural part, a thermal part, or an electromechanical part, or combinations thereof.

4. The apparatus of claim 3, wherein the mechanical coupling comprises one or more of a nut, a bolt, a screw, or a rivet, or a combination thereof.

5. The apparatus of claim 1, wherein the sensor assembly comprises a RFID tag coupled to the measuring device.

6. The apparatus of claim 1, wherein the sensor assembly is capable of receiving at least a portion of power from a wireless monitor assembly positioned remotely from the sensor assembly.

7. The apparatus of claim 1, wherein the sensor assembly further comprises:
a processor coupled to the measuring device and coupled to the wireless communication system, wherein the processor is capable of polling the measuring device;
a power storage coupled to the wireless communication system and coupled to the processor, wherein the power storage is capable of receiving power from the wireless communication system and capable of delivering power to the processor; and
an antenna coupled to the wireless communication system.

8. The apparatus of claim 1, wherein the sensor assembly further comprises:
a processor coupled to the measuring device and coupled to the wireless communication system, wherein the processor is capable of polling the measuring device in response to a signal from the wireless communication system;
a power source coupled to the processor, wherein the power source is capable of delivering power to the processor; and
an antenna coupled to the wireless communication system.

9. The apparatus of claim 1, wherein the sensor assembly further comprises:
a power extraction device coupled to the measuring device, wherein the power extraction device is capable of extracting power from strain on the mechanical component and capable of delivering power to the measuring device;
a memory coupled to the measuring device and coupled to the wireless communication system, wherein the memory is capable of storing data delivered from the measuring device;
a power storage coupled to the wireless communication system, coupled to the power extraction device, and coupled to the memory, wherein the power storage is capable of receiving power from the wireless communication system and from the power extraction device and capable of delivering power to the memory; and
an antenna coupled to the wireless communication system.

10. A method, comprising:
measuring strain from a sensor assembly attached to a mechanical component; and
communicating the measured strain via a wireless link.

11. The method of claim 10, further comprising communicating the measured strain via a wireless link to a remote receiver.

12. The method of claim 10, wherein said measuring strain from the sensor assembly comprises polling a measuring device for the measured strain.

13. The method of claim 10, wherein said measuring strain from the sensor assembly comprises receiving the measured strain from a measuring device upon a change of condition determined by measuring device.

14. The method of claim 10, further comprising receiving at least a portion of power from a wireless monitor assembly positioned remotely from the sensor assembly.

15. The method of claim 14, further comprising storing at least a portion of the received power from the wireless monitor assembly.

16. The method of claim 10, further comprising extracting at least a portion of power from strain on the mechanical component and delivering said portion of power to the sensor assembly.

17. A system, comprising:
a mechanical component;
a sensor assembly attached to the mechanical component, wherein the sensor assembly comprises:
a measuring device, and
a wireless communication system coupled to the measuring device; and
a monitor assembly capable of communication with the sensor assembly via a wireless link.

18. The system of claim 17, wherein the measuring device comprises a strain measuring device.

19. The system of claim 17, wherein the mechanical component comprises one or more of the following a mechanical coupling, a structural part, a thermal part, or an electromechanical part, or combinations thereof.

20. The system of claim 19, wherein the mechanical coupling comprises one or more of a nut, a bolt, a screw, or a rivet, or a combination thereof.

21. The system of claim 17, wherein the sensor assembly comprises a RFID tag coupled to the measuring device.

22. The system of claim 17, wherein the sensor assembly is capable of receiving at least a portion of power from the wireless monitor assembly positioned remotely from the sensor assembly.

23. The system of claim 17, wherein the wireless monitor assembly comprises a wireless reader coupled to an antenna.

24. The system of claim 17, wherein the sensor assembly further comprises:
a processor coupled to the measuring device and coupled to the wireless communication system, wherein the processor is capable of polling the measuring device;
a power storage coupled to the wireless communication system, coupled to the power extraction device, and coupled to the processor, wherein the power storage is capable of receiving power from the wireless communication system and from the power extraction device and capable of delivering power to the processor; and
an antenna coupled to the wireless communication system.

25. The system of claim 17, wherein the sensor assembly further comprises:
a processor coupled to the measuring device and coupled to the wireless communication system, wherein the processor is capable of polling the measuring device in response to a signal from the wireless communication system;
a power source coupled to the processor, wherein the power source is capable of delivering power to the processor; and
an antenna coupled to the wireless communication system.

26. The system of claim 17, wherein the sensor assembly further comprises:
a power extraction device coupled to the measuring device, wherein the power extraction device is capable of extracting power from on the mechanical component and capable of delivering power to the measuring device;
a memory coupled to the measuring device and coupled to the wireless communication system, wherein the memory is capable of storing data delivered from the measuring device;
a power storage coupled to the wireless communication system and coupled to the memory, wherein the power storage is capable of receiving power from the wireless communication system and capable of delivering power to the memory; and
an antenna coupled to the wireless communication system.

27. An apparatus, comprising:
a measuring device capable of sensing one or more stimuli; and
a RFID tag coupled to the measuring device, wherein the RFID tag is capable of communicating the sensed stimuli via a wireless link.

28. The apparatus of claim 27, further comprising a power extraction device coupled to the measuring device, wherein the power extraction device is capable of extracting power from external and capable of delivering power to the measuring device.
